(19) United States
(12) Patent Application Publication
(10) Pub. No.: US 2023/0144113 A1
(43) Pub. Date: May 11, 2023

(54) FORWARD MARKETS TO INCREASE INFORMATIONAL CERTAINTY AND DECREASE RISK IN LOGISTICS

(71) Applicant: X Development LLC, Mountain View, CA (US)

(72) Inventors: Salil Vijaykumar Pradhan, San Jose, CA (US); Grigory Bronevetsky, San Ramon, CA (US); Ryan Butterfoss, San Francisco, CA (US); Rebecca Radkoff, San Francisco, CA (US); David Andre, San Francisco, CA (US); Randolph Preston McAfee, San Marino, CA (US); John Michael Stivoric, Pittsburgh, PA (US); Grace Taixi Brentano, Redwood City, CA (US); Sze Man Lee, Milpitas, CA (US)

(21) Appl. No.: 17/984,185

(22) Filed: Nov. 9, 2022

Related U.S. Application Data
(60) Provisional application No. 63/277,592, filed on Nov. 9, 2021.

(51) Int. Cl. G06Q 10/08; G06Q 10/06; G06Q 30/06

(52) U.S. Cl. CPC G06Q 10/08345; G06Q 10/067; G06Q 30/0611

(57) ABSTRACT

Methods and systems including receiving a plurality of shipping bids from a plurality of shipping entities, each entity having goods to ship from locations to destinations, wherein each bid represents an option to ship goods at a shipping price, and wherein each bid comprises a plurality of shipping parameters; receiving a plurality of carrier bids from a plurality of carrier entities, each entity transporting the goods, wherein each bid represents an option to transport the goods at a price, and wherein each bid comprises a plurality of carrier parameters; performing a matching process to generate a plurality of pair-wise partial matches, wherein each match associates a shipping and carrier bid at a modified price, wherein the modified price is based on a deviation between the parameters; providing information representing the matches to the shipping and carrier entities; and generating training data representing which matches were exercised.

### CROSS-REFERENCE TO RELATED APPLICATIONS

This application claims priority to U.S. application Ser. No. 63/277,592 , filed Nov. 9, 2021, the contents of which are incorporated herein by reference in their entirety.

### TECHNICAL FIELD

This disclosure generally relates to supply chain logistics.

### BACKGROUND

Supply chains transport objects between various locations. For example, a supply chain may include a truck that transports textiles from a shipping port to a factory, and include another truck that transports toys made with the textiles from the factory to a retailer.

### SUMMARY

In general, an aspect of the subject matter described in this specification relates to forward markets for logistics. Logistics may involve the coordination of storing and transporting objects within a supply chain. For example, trucks may be assigned to various geographically distributed locations so that all locations have some trucks available for transport.

However, issues may arise in logistics when transportation expectations differ from actual transportation needs. For example, a company may sign a contract for an average truck usage and, during periods of especially high usage that exceed the contracted average, the company may need to buy excess truck usage. This may introduce risk as the cost of excess truck usage at the time needed may be much higher than the cost of contracting for average truck usage in the future.

A system may decrease risk in logistics by providing options for transportation ahead of time, where the options may be later exercised to provide transportation of objects. For example, an option may provide the right to transport a truckload of objects from a particular origin city to a particular destination city at a particular cost on a particular date. Providing options ahead of time may create greater certainty and more data and visibility on logistics. For example, demand for a particular option may indicate that objects will likely be transported on the corresponding route on the corresponding day.

The system may use the additional data and visibility on logistics to create models that better predict transportation usage in the supply chain, and those predictions may be used to better coordinate storage and transportation of objects within the supply chain. For example, the system may determine that options for transportation between a particular set of cities are being frequently exercised and, in response, increase transportation capacity between the cities.

In some aspects, the subject matter described in this specification may be embodied in methods that may include the actions of generating an option that represents transportation of a load from a specific city, determining a price of the option based on a simulation of a supply chain that includes the specific city, determining that the option was exercised, and based on determining that the option was exercised, modifying the supply chain.

Particular embodiments of the subject matter described in this specification can be implemented so as to realize one or more of the following advantages. The techniques described in this specification can allow users to quickly build and execute simulations on historical data that capture the effects of forward market conditions. Additional advantages include a reduction in “idle time” of carrier or shipper assets, increased profitability, a lower carbon footprint realized through more effective shipping asset utilization, a reduction in warehouse or network backups, reduced road or supply network congestion, supply chain shortage prevention, risk reduction achieved through better market simulation, increased confidence in substantial or expensive business decisions, and an increased ability to access forward markets.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1A illustrates an example system for collecting and analyzing bids from carriers and shippers.

FIG. 1B illustrates an example supply chain of carriers and destinations.

FIG. 2 illustrates a flowchart of an example process that describes a matching process for real-world carriers and shippers.

FIG. 3 illustrates a flowchart of an example process where a simulation is generated from supply chain training data.

FIG. 4 illustrates a flowchart of an example process that provides forward markets for logistics.

FIG. 5 illustrates a schematic diagram of an exemplary generic computer system.

Like reference symbols in the various drawings indicate like elements.

### DETAILED DESCRIPTION

A system as discussed in this specification can provide simulations of forward markets for logistics. The system can include a computing device that generates options that may be exercised to provide transportation of objects. In some implementations, the options can be for a particular truck for a particular date for a pair of particular origin city and destination city, where the particular truck is to move a load from the origin city to the destination city on the particular date. Options can be priced according to how far in advance they are purchased and the exercise date. For example, the system can generally determine lower prices for options that are further from the exercise date.

In some implementations, price may decrease as more information is provided. For example, if a customer indicates that they are purchasing an exclusive or (XOR) of four options wherein only one of the bundle may ultimately be exercised and receive a lower price than purchasing the four options without such indication because the indication may be very valuable for the truck carrier company, e.g., using the information the carrier company may realize they can only have one truck on standby for the four options instead of four trucks for the four options. In another example, a customer may receive a discount by providing a simulation (black box or otherwise) of the entire business operations which would provide maximal information to the carrier, and additionally or alternatively could be used as an informational input into Fractal's end-to-end simulation of the supply chain.

In some implementations, options can be offered in addition to normal contract pricing and spot markets, and the options may be favored over time due to competitive pricing and increased level of clarity about the customer's needs.

In some implementations, an option can be for a truck leaving from a specific city (no origin destination pair) at an estimated average price. In some cases, this type of option can be a way for carriers, customers, and drivers to offload risk and makes room for financial players to assume said risk and potentially profit off of it. In some cases, players in this marketplace can collect information to create models to predict popularity and pricing of high density hubs. In some cases, this may not affect the actual transportation of goods and can instead be buying and selling of options based on risk. In some implementations, contract purchases in the marketplace can be resold and repriced at the time of sale.

In some implementations, the system may dynamically adjust the price of an option based on continuing simulation results. In some implementations, the options may be unregulated and not exchanged-traded. In some cases, structure and guarantee can come from the peer-to-peer contracts. In some cases, a system can eventually make options tradeable to be used in the marketplace so that any players can buy without establishing a long-term contract.

In some implementations, the system can build out an artificial intelligence platform in which there could potentially be financial compensation for the provision of data that is useful for simulation modeling.

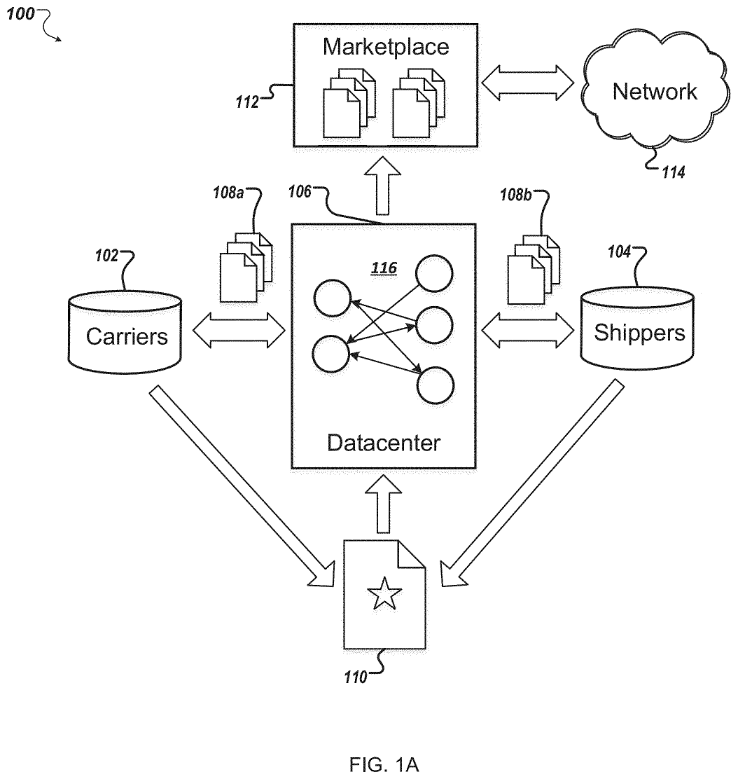

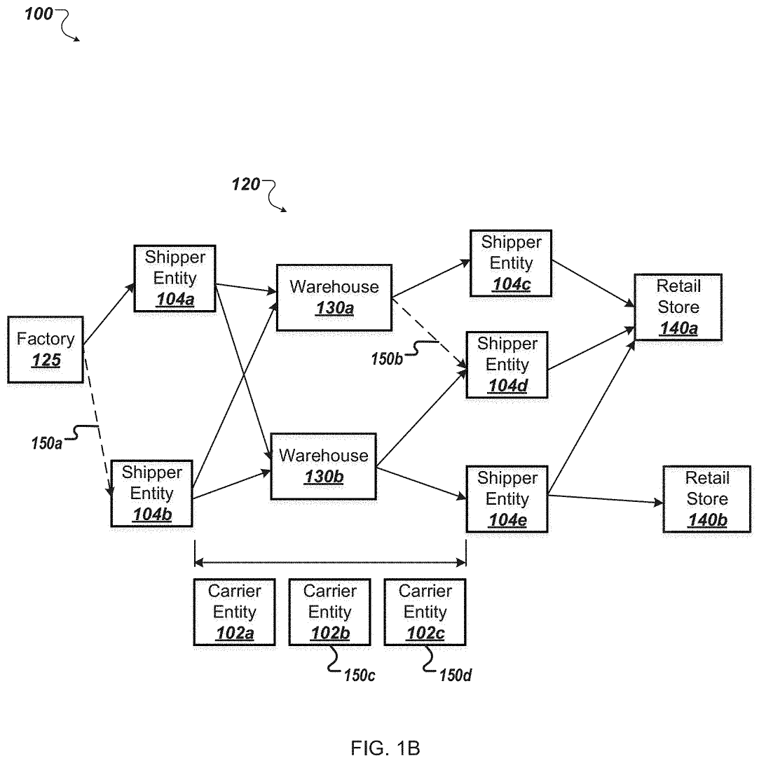

FIG. 1A illustrates an example system 100 for collecting and analyzing bids from carriers and shippers. The system 100 includes a plurality of real-world carriers 102, a plurality of real-world shippers 104, a database 106, a plurality of bids 108, and a plurality of exercised contracts 110. The system 100 also optionally includes a marketplace 112 and one or more networks 114.

In some implementations, datacenter 106 receives bids 108 from the plurality of carriers 102 and shippers 104. In some cases, these bids 108 can reflect different shipping or contract requirements for each of the carriers 102 and shippers 104. For example, for shipping cargo from Los Angeles to New York, a shipper 104 may submit bid 108b that includes a required time and level of insurance coverage. Likewise, for the same shipping event, a carrier 102 may submit bid 108a that includes a required price that the carrier 102 would need to be paid in order for the contract to be profitable at the shipper's terms. In some implementations, the conditions of bids 108a and 108b can originally have a divergence such that a carrier 102 would not accept a shipper bid 108b and a shipper 104 would not pay a carrier bid 108a.

In some implementations, the datacenter 106 can perform a partial matching process 116 for bids 108a and 108b designed to identify carriers 102 and shippers 104 where engagement may be possible under modified terms. In some cases, this partial matching process 116 can be used to determine if modifications to bids 108a or 108b would be mutually acceptable to the carrier 102 or shipper 104.

In some implementations, this partial matching process 116 generates a plurality of partial matches that each propose a contract associated with bids 108a and 108b. In some cases, these partial matches can represent a modified contract price for the shipping event for which the bids 108 were obtained. In some cases, this modified contract price can reflect a deviation from the terms outlined in bids 108. For example, if a shipper bid 108b required a package to be shipped from Los Angeles to New York at a price that was originally unacceptable to carrier 102, the deviation may be altering the route such that the package is shipped from Los Angeles to Philadelphia at a price that would be acceptable to the carrier 102. This example is only one possible outcome in a plurality of partial matches presented to carriers 102 and shippers 104. Other examples of deviations could be a modified shipping timeline, a different level of insurance coverage, or a different shipping method.

In some implementations, presenting these partial matches to the carriers 102 or shippers 104 can introduce market options not previously considered by either side. For example, receiving a partial match that describes the modified shipping route above could motivate a carrier 102 to move additional assets to cover the forward market for that route. In this way, carriers 102 and shippers 104 can more effectively manage risk when serving forward markets.

In some implementations, to improve the accuracy of the deviations developed by partial matching process 116, training data can be generated based on exercised contracts 110. In some cases, exercised contracts 110 were contracts accepted by the carriers 102 or shippers 104. In some cases, these exercised contracts included deviations applied during the partial matching process 116.

In some implementations, this training data can be used to iteratively modify future deviations generated by partial matching process 116 such that they have a higher probability of being accepted by carriers 102 and shippers 104. In some implementations, deviations can be iteratively varied by a machine learning model that receives the training data on which contracts 110 were exercised. In some cases, training data can also be provided to the database 106 by other means. For example, carriers 102 and shippers 104 may decide to provide past examples of exercised contracts not generated by the partial matching process 116 which can be used to train the machine learning model without running a new simulation.

In some implementations, the partial matching process 116 can create supply chain simulations for the carriers 102 and shippers 104, independent of training data. In some cases, these supply chain simulations can include “worlds” where additional supply chain links exist between carriers 102 and shippers 104. In other cases, the supply chain worlds can vary different input parameters and requirements from carriers 102 or shippers 104.

In some implementations, supply chain world simulations can be compared to performance thresholds that represent requirements of the carriers 102 and shippers 104. In some cases, the partial matching process 116 can utilize a reinforcement training model to better model the actions and performance thresholds of carriers 102 and 104.

In some implementations, the partial matching process 116 can determine that certain deviations and supply chain worlds satisfy certain performance thresholds. In some cases, the partial matching process 116 may present these deviations to the carriers 102 and shippers 104 as “suggestions.” In some cases, suggestions represent alterations to input parameters or requirements that allow carriers 102 or shippers 104 to satisfy their requirements through a modified supply chain not previously considered.

In some implementations, the partial matches generated by the partial matching process 116 can be provided to additional third parties separate from the carrier 102 or shipper 104 for which the matches were originally generated. In some cases, providing this information to these additional parties can better alert them to the impact of forward markets discovered during the partial matching process 116 for like entities. In some implementations, this information can be made accessible in a “marketplace” that acts as a repository for previous matching information. In some cases, this information can be made available over a network, for example, the Internet.

FIG. 1B illustrates an example supply chain 120 of carriers 102, shippers 104, and destinations. The example supply chain 120 includes a factory 125, a plurality of carrier entities 102, a plurality of shipper entities 104, a plurality of warehouses 130, and a plurality of retail stores 140. Each of these entities should be regarded as separate where indicated, such that carrier 102a is a different entity than carrier 102b.

In some implementations, the supply chain network 120 includes many different destinations and entities that are required to handle a set of goods throughout the shipping process. For example, in the example supply chain network 120 of FIG. 1B, goods originate at factory 125 and then are shipped by shipper 104a to warehouse 130a. After the goods are received by warehouse 130a, they are then shipped by shipper 104c to retail store 140a. Other possible examples of shipping paths are evident from the figure.

In some implementations, when partial matching process 116 generates suggestions for alterations to a supply chain network 120, new pathways 150 are presented. These new pathways 150 can include new shipping routes not previously considered, new carriers 102 not previously utilized by a shipper 104, or other substantial changes to the supply chain network 120. For example, while supply chain 120 illustrates that goods usually are transported from factory 125 to warehouse 130a by shipper 104a, a new pathway 150a can utilize shipper 104b to ship the goods to warehouse 130a or 130b. An additional example can be shipper 104b using carrier entities 102b or 102c, instead of 102a, to transport goods along its contracted route. Other possible new pathways 105 are presented in the figure. In some cases, multiple new pathways 105 may be presented to the carrier 102 or shipper 104 as suggestions from the partial matching process 116.

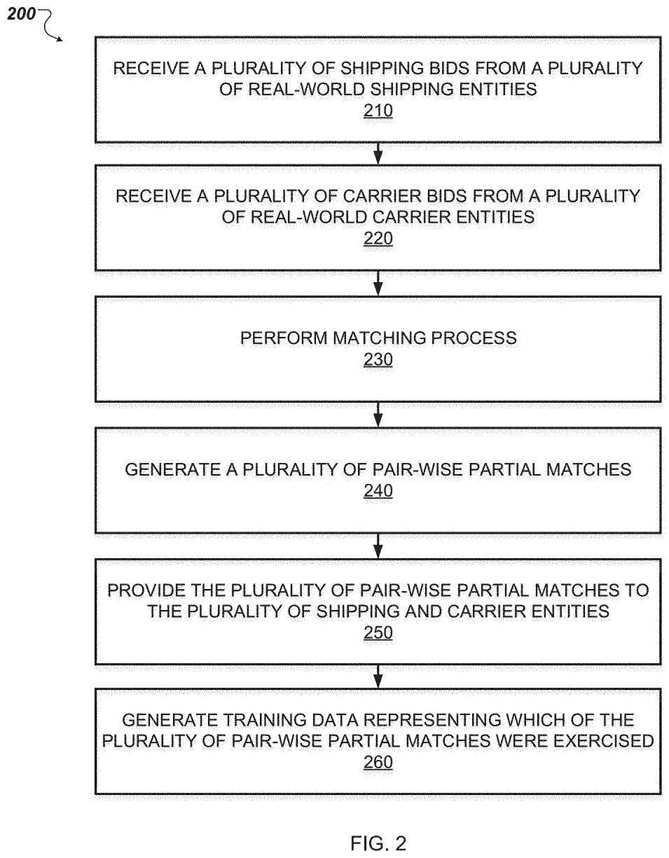

FIG. 2 illustrates a flowchart of an example process 200 that describes a matching process for real-world carriers and shippers. The process 200 includes receiving a plurality of shipping bids from a plurality of real-world shipping entities (210). For example, a shipping agency that manages the transport of small parcels may submit a bid with their requirements to transport a package from Los Angeles to New York by next Thursday. Other requirements within the bid could include a desired route, shipping method (air, ground, sea), or contract price.

The process 200 includes receiving a plurality of carrier bids from a plurality of real-world carrier entities (220). For example, a carrier may submit a required contract price that would need to be paid to meet the requirements of the shipper. Other requirements within the bid could include an air freight company providing a standard per-mile billing rate, a maritime shipping company specifying a minimum amount of insurance a shipper must purchase, or other contract requirements as specified by the carrier.

The process 200 includes performing matching process (230). In some implementations, this matching process can examine for similarities within the carrier and shipper bids for mutually acceptable areas, and areas that may be mutually acceptable with a certain deviation to one or both of the carrier or shipper bids.

The process 200 includes generating a plurality of pair-wise partial matches (240). In some implementations, these pair-wise partial matches comprise situations where the bids submitted by the carriers and shippers are mutually acceptable, or may be mutually acceptable with a certain deviation to one or both of the carrier or shipper bids.

The process 200 includes providing the plurality of pair-wise partial matches to the plurality of shipping and carrier entities (250). In some implementations, the carriers and shippers may choose to exercise one or more of the pair-wise partial matches.

The process 200 includes generating training data representing which of the plurality of pair-wise partial matches were exercised (260). In some implementations, this training data can be provided to a machine learning model to better predict what deviations are preferential to a carrier or shipper.

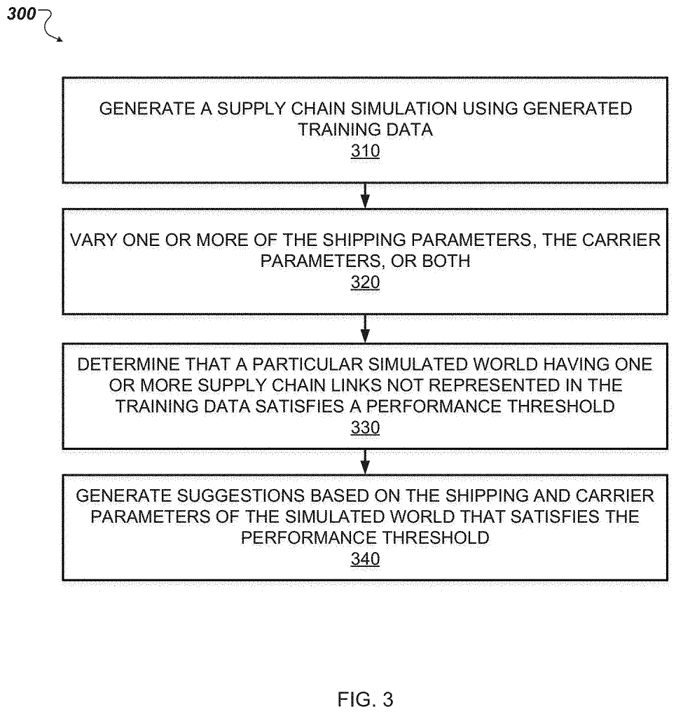

FIG. 3 illustrates a flowchart of an example process 300 where a simulation is generated from supply chain training data. The process 300 includes generating a supply chain simulation using generated training data (310). In some implementations, this supply chain simulation represents assets available to the carrier or shipper along with known routes and networks. Other implementations can include additional information that is relevant to understanding the supply chain, for example, a process that must occur for certain types of packages, or a shipping requirement for a certain type of good. In some implementations, this supply chain simulation can be referred to as a simulated world.

The process 300 includes varying one or more of the shipping parameters, the carrier parameters, or both (320). In some implementations, this variation can include a modified shipping route, a modified shipping timeline, a different level of insurance coverage, or a different shipping method. Additional examples of variations can include additional shipping routes not considered by the current supply chain, additional carrier or shipper entities not previously utilized, or other substantial changes to the supply chain network itself. In some cases, many variations can be generated for a single set of bids. In some cases, these variations can each vary a different parameter, such that one set of variations presents options for modified insurance coverage with a given shipper while another set of variations presents options using different shippers entirely.

The process 300 includes determining that a particular simulated world having one or more supply chain links not represented in the training data satisfies a performance threshold (330). In some implementations, this performance threshold can correspond to a parameter of the carrier or shipper bid.

The process 300 includes generating suggestions based on the shipping and carrier parameters of the simulated world that satisfies the performance threshold (340). In some implementations, these suggestions can be provided to the carrier or shipper such that they can examine and accept the suggestion. In some cases, a modified contract based on the suggestion can be created between the carrier and shipper.

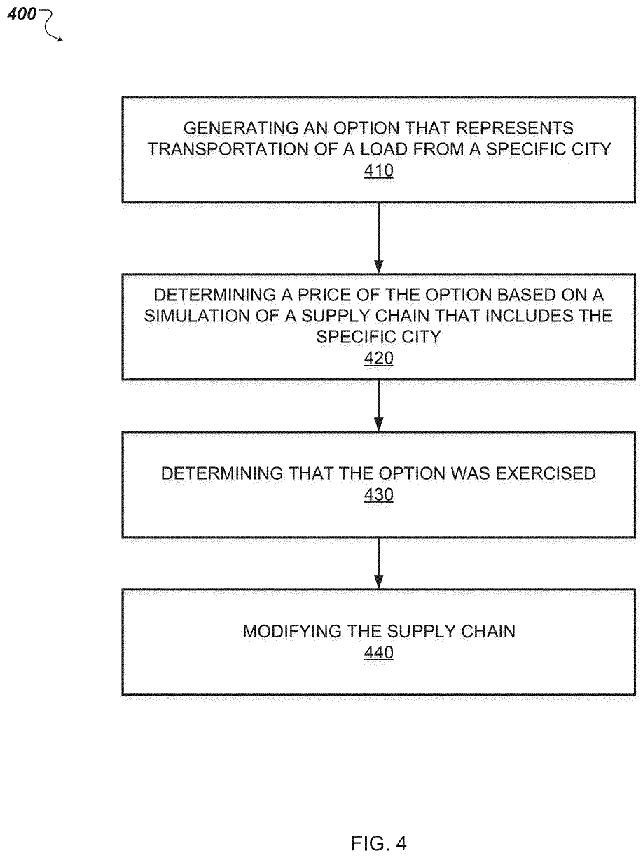

FIG. 4 illustrates a flowchart of an example process 400 that provides forward markets for logistics. The process 400 includes generating an option that represents transportation of a load from a specific city (410). For example, the system can generate an option that represents a right to transport one thousand cubic feet from Miami, FL to Washington, D.C. on a future date of Nov. 9, 2051 for an exercise cost of $200.

The process 400 includes determining a price of the option based on a simulation of a supply chain that includes the specific city (420). For example, the system can simulate the supply chain and determine based on expected truck availability on Nov. 9, 2051 in Miami, Fla., that the cost to purchase the option is $150 as the actual cost to transport is expected to by $350, a total of the purchase cost of the option and the exercise cost of the option.

The process 400 includes determining that the option was exercised (430). For example, the system can receive an indication from a client device, of a holder of the option, that the option was exercised for transportation on the date of Nov. 9, 2051.

The process includes, based on determining that the option was exercised, modifying the supply chain (440). For example, based on the exercise of the option, the system can determine that future demand for transportation in Miami has likely increased and, in response, assign two additional trucks to Miami, Fla. for the next two weeks.

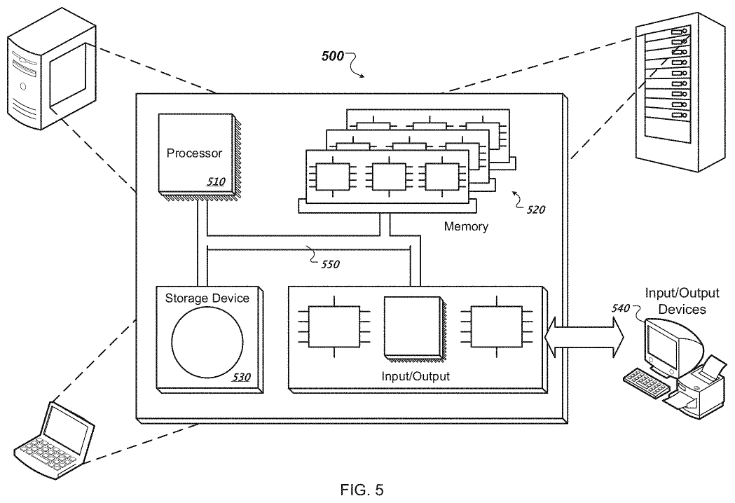

FIG. 5 illustrates a schematic diagram of an exemplary generic computer system 500. The system described above may be implemented on the system 500.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, a solid state drive, an optical disk device, a tape device, universal serial bus stick, or some other storage device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a rail trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other. The servers may be part of a cloud, which may include ephemeral aspects.

In addition to the embodiments described above, the following embodiments are also innovative:

Embodiment 1 is a method comprising:
receiving a plurality of shipping bids from a plurality of real-world shipping entities, each shipping entity being an entity having goods to ship from one or more locations to one or more destinations, wherein each shipping bid represents an option to ship a particular quantity of goods in the future at a particular shipping price, and wherein each shipping bid comprises a plurality of shipping parameters;
receiving a plurality of carrier bids from a plurality of real-world carrier entities, each carrier entity being an entity that provides transportation services for transporting goods, wherein each carrier bid represents an option to transport a particular quantity of goods in the future at a particular carrier price, and wherein each carrier bid comprises a plurality of carrier parameters;
performing a matching process to generate a plurality of pair-wise partial matches, wherein each pair-wise partial match associates a shipping bid with a carrier bid at a modified price, wherein the modified price is based on a deviation between shipping parameters of the shipping bid and carrier parameters of the carrier bid;
providing information representing the plurality of pair-wise partial matches to the plurality of real-world shipping entities and the plurality of real-world carrier entities; and generating training data representing which of the plurality of pair-wise partial matches were exercised.

Embodiment 2 is the method of embodiment 1, further comprising:
generating a supply chain simulation using the generated training data, wherein the supply chain simulation varies one or more of the shipping parameters, the carrier parameters, or both;
determining that a particular simulated world having one or more supply chain links not represented in the training data satisfies a performance threshold; and
generating a suggestion based on the shipping parameters and carrier parameters of the simulated world that satisfies the performance threshold.

Embodiment 3 is the method of embodiment 2, wherein generating the supply chain simulation comprises executing a reinforcement learning model to simulate actions of carrier entities and shipping entities.

Embodiment 4 is the method of embodiment 2, wherein the varying of one or more shipping parameters is refined using a machine learning model based on which of the plurality of pair-wise partial matches were exercised.

Embodiment 5 is the method of any one of embodiments 1-4, wherein the information corresponding to the plurality of pair-wise partial matches is provided to a different shipper or carrier not associated with the plurality of pair-wise partial matches.

Embodiment 6 is the method of embodiment 5, wherein the information corresponding to the plurality of pair-wise partial matches is made available in a marketplace.

Embodiment 7 is the method of embodiment 6, wherein the marketplace is accessible over a network.

Embodiment 8 is the method of any one of embodiments 1-7, wherein the training data is received directly from shippers or carriers.

Embodiment 9 is the method of any one of embodiments 1-8, wherein the deviation comprises a shipping destination.

Embodiment 10 is the method of any one of embodiments 1-9, wherein the deviation comprises an amount of insurance.

Embodiment 11 is the method of any one of embodiments 1-10, wherein the deviation comprises a different shipping timeline.

Embodiment 12 is the method of any one of embodiments 1-11, wherein the deviation comprises a different shipping method.

Embodiment 13 is a computer-implemented method comprising:
generating an option that represents transportation of a load from a specific city;
determining a price of the option based on a simulation of a supply chain that includes the specific city;
determining that the option was exercised; and
based on determining that the option was exercised, modifying the supply chain.

Embodiment 14 is a system comprising: one or more computers and one or more storage devices storing instructions that are operable, when executed by the one or more computers, to cause the one or more computers to perform the method of any one of embodiments 1 to 13.

Embodiment 15 is a computer storage medium encoded with a computer program, the program comprising instructions that are operable, when executed by data processing apparatus, to cause the data processing apparatus to perform the method of any one of embodiments 1 to 13.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a plurality of shipping bids from a plurality of real-world shipping entities, each shipping entity being an entity having goods to ship from one or more locations to one or more destinations, wherein each shipping bid represents an option to ship a particular quantity of goods in the future at a particular shipping price, and wherein each shipping bid comprises a plurality of shipping parameters;
receiving a plurality of carrier bids from a plurality of real-world carrier entities, each carrier entity being an entity that provides transportation services for transporting goods, wherein each carrier bid represents an option to transport a particular quantity of goods in the future at a particular carrier price, and wherein each carrier bid comprises a plurality of carrier parameters;
performing a matching process to generate a plurality of pair-wise partial matches, wherein each pair-wise partial match associates a shipping bid with a carrier bid at a modified price, wherein the modified price is based on a deviation between shipping parameters of the shipping bid and carrier parameters of the carrier bid;
providing information representing the plurality of pair-wise partial matches to the plurality of real-world shipping entities and the plurality of real-world carrier entities; and
generating training data representing which of the plurality of pair-wise partial matches were exercised.

2. The method of claim 1, further comprising:
generating a supply chain simulation using the generated training data, wherein the supply chain simulation varies one or more of the shipping parameters, the carrier parameters, or both;
determining that a particular simulated world having one or more supply chain links not represented in the training data satisfies a performance threshold; and
generating a suggestion based on the shipping parameters and carrier parameters of the simulated world that satisfies the performance threshold.

3. The method of claim 2, wherein generating the supply chain simulation comprises executing a reinforcement learning model to simulate actions of carrier entities and shipping entities.

4. The method of claim 2, wherein the varying of one or more shipping parameters is refined using a machine learning model based on which of the plurality of pair-wise partial matches were exercised.

5. The method of claim 1, wherein the information corresponding to the plurality of pair-wise partial matches is provided to a different shipper or carrier not associated with the plurality of pair-wise partial matches.

6. The method of claim 5, wherein the information corresponding to the plurality of pair-wise partial matches is made available in a marketplace.

7. The method of claim 6, wherein the marketplace is accessible over a network.

8. The method of claim 1, wherein the training data is received directly from shippers or carriers.

9. The method of claim 1, wherein the deviation comprises a shipping destination.

10. The method of claim 1, wherein the deviation comprises an amount of insurance.

11. The method of claim 1, wherein the deviation comprises a different shipping timeline.

12. The method of claim 1, wherein the deviation comprises a different shipping method.

13. A system comprising:
one or more computers and one or more storage devices storing instructions that are operable, when executed by the one or more computers, to cause the one or more computers to perform operations comprising:
receiving a plurality of shipping bids from a plurality of real-world shipping entities, each shipping entity being an entity having goods to ship from one or more locations to one or more destinations, wherein each shipping bid represents an option to ship a particular quantity of goods in the future at a particular shipping price, and wherein each shipping bid comprises a plurality of shipping parameters;
receiving a plurality of carrier bids from a plurality of real-world carrier entities, each carrier entity being an entity that provides transportation services for transporting goods, wherein each carrier bid represents an option to transport a particular quantity of goods in the future at a particular carrier price, and wherein each carrier bid comprises a plurality of carrier parameters;
performing a matching process to generate a plurality of pair-wise partial matches, wherein each pair-wise partial match associates a shipping bid with a carrier bid at a modified price, wherein the modified price is based on a deviation between shipping parameters of the shipping bid and carrier parameters of the carrier bid;
providing information representing the plurality of pair-wise partial matches to the plurality of real-world shipping entities and the plurality of real-world carrier entities; and
generating training data representing which of the plurality of pair-wise partial matches were exercised.

14. The system of claim 13, further comprising:
generating a supply chain simulation using the generated training data, wherein the supply chain simulation varies one or more of the shipping parameters, the carrier parameters, or both;
determining that a particular simulated world having one or more supply chain links not represented in the training data satisfies a performance threshold; and
generating a suggestion based on the shipping parameters and carrier parameters of the simulated world that satisfies the performance threshold.

15. The system of claim 14, wherein generating the supply chain simulation comprises executing a reinforcement learning model to simulate actions of carrier entities and shipping entities.

16. The system of claim 14, wherein the varying of one or more shipping parameters is refined using a machine learning model based on which of the plurality of pair-wise partial matches were exercised.

17. The system of claim 13, wherein the information corresponding to the plurality of pair-wise partial matches is provided to a different shipper or carrier not associated with the plurality of pair-wise partial matches.

18. The system of claim 17, wherein the information corresponding to the plurality of pair-wise partial matches is made available in a marketplace.

19. The system of claim 13, wherein the training data is received directly from shippers or carriers.

20. A computer-implemented method comprising:
generating an option that represents transportation of a load from a specific city;
determining a price of the option based on a simulation of a supply chain that includes the specific city;
determining that the option was exercised; and
based on determining that the option was exercised, modifying the supply chain.
